(19) United States
(12) Patent Application Publication
(10) Pub. No.: US 2017/0359960 A1
(43) Pub. Date: Dec. 21, 2017

(54) METHOD AND SYSTEM FOR METHOD FOR PROVIDING A BALE OF CROP MATERIAL

(71) Applicant: Forage Innovations B.V., Maassluis (NL)

(72) Inventors: Willem Jacobus Reijersen van Buuren, Dirksland (NL); Mark Core, Pleasantville, IA (US)

(73) Assignee: Forage Innovations B.V., Maassluis (NL)

(21) Appl. No.: 15/339,614

(22) Filed: Oct. 31, 2016

(30) Foreign Application Priority Data
Jun. 15, 2016 (NL) 2016962

(51) Int. Cl. A01F 15/07; B65B 11/04; B65B 61/00

(52) U.S. Cl. CPC A01F 15/0715; B65B 61/007; B65B 11/04; A01F 2015/077; A01F 2015/074

(57) ABSTRACT

In a method for providing a bale of crop material that is only partially wrapped in a film, a bale of crop material is wrapped in a film with an automatic bale wrapping apparatus. Subsequently the film is provided with a plurality of perforations, and it is ensured that the perforations are present/positioned in an upper half of the bale. This ensures that there is good moisture control of the bale, with moist air able to escape, while stopping ingress of rain water. The bales are mostly dry hay or the like, and favourable perforations are radial slits. There is also provided a system for providing such bales with position controlled perforations.

### CROSS-REFERENCE TO RELATED APPLICATION

This application claims priority to Netherlands Patent Application No. 2016962, filed Jun. 15, 2016, which is incorporated herein by reference in its entirety.

### FIELD OF THE DISCLOSURE

The present invention relates to a method for providing a bale of crop material that is only partially wrapped in a film which is provided with a plurality of perforations, the method comprising wrapping a bale of crop material in a film with an automatic bale wrapping apparatus.

### BACKGROUND

Baling of crop is carried out when storing the crop for a longer time, to protect it against the climate, such as rain and moisture. The baling provides a high density of the crop, and also, in particular in round bales, that rain will easily run off the sides of a bale. However, baling along is not enough to protect the crop sufficiently in any climate but the driest. Therefore, the bale is most often wrapped in a watertight film. For many crops, it is necessary to fully envelop the bale with the film. But this requires complex machinery and it is expensive. Therefore, some types of crop are only partially enveloped with film.

In practice it is found that such bales of dry material, partially wrapped in film, will still foul in many situations, or at least show an undesirable quality loss of the crop. Thereto, it has been proposed to provide the film with perforations, which allows the escape of water or moisture that is still present, or has been accumulated, in the crop. An example hereof can be found in prior art document CA2466713, that discloses a bale wrapped in micro perforated film. Here the film is provided with microperforations throughout, and is locally provided with extra material, to be manipulated into ground contact. Furthermore, WO2014/106835 discloses a method of securing wrap film on a bale, by heat melting, possibly with perforating, a film tail to the other layers of film around a bale. This is in itself not related to moisture control perforations, and the position or other properties of such perforations is not at all discussed.

Although an improvement, it is still found to be unsatisfactory in some cases, and the present invention aims at providing a method, and a system, for providing a bale of crop material that allows an even better storage of such bales, with less quality loss in many circumstances.

### SUMMARY

The invention achieves the object with a method according to claim 1, in particular a method for providing a bale of crop material that is only partially wrapped in a film which is provided with a plurality of perforations, the method comprising the steps of wrapping a bale of crop material in a film with an automatic bale wrapping apparatus, subsequently providing the film with said plurality of perforations, and ensuring that the perforations are present/positioned in an upper half of the bale. Herein, the invention uses the following insight. The baled crops, when stored, will always be subject to changing weather conditions. This is felt most strongly when bales are left outside for months, under a blazing sun but much lower temperatures at night. In those circumstances, moisture in the bale will evaporate into the air within the bale. At night, under circumstances where the air can contain less moisture, this will condense, such as at the colder surface of the film or even directly in the crop material. It is in particular this collected water, together with the available air, that sometimes causes moulding and other degradation of crop material. Now, according to the invention, such collecting of water is prevented by allowing the moisture-laden air to escape from the bale. Thereto, perforations are provided in the film. But it is also important that those perforations are provided in the top half of the bale, and preferably more to the top, because the heated air with the moisture will rise to the top, where the temperature differences are highest. It does not make much sense to provide perforations all over the bale, as is done in some prior art methods, because not only are perforations in the lower half of the bale, or even near ground level, not effective in letting out moist air, it also allows moisture from dew, fog et cetera into the bale, which is undesirable. It is therefore important to ensure that the perforations are present in the top half of the bale. And if it cannot be ensured both that the perforations are provided at the top and that the bale does not rotate or otherwise shift after providing the rotations, then at least it is to be ensured that the provided perforations will be moved to the upper bale half, by rotating or otherwise shifting the bale. This will be explained below, in the light of specific embodiments, given only as explanatory information and in no way meant to limit the general inventive concept.

It is noted that in some prior art methods, there is provided a film with prefab perforations. In view of the present invention, this needlessly entails the risk that the perforations end up in the wrong position, such as only in the lower half, or even all over or around the bale, which does not allow the perforations to be provided only in the upper half of the bale. In any case, it would be much more complex to ensure the right positions.

Based on the above consideration with respect to the present invention, it will be clear that there are preferably no perforations in the lower half of the bale film. Furthermore, the crop material is in particular, though not exclusively, a dry crop such as hay, with a low moisture content of less than 25%, such as between 12 and 20%, depending on type and size of bale, and on type of crop material. Moreover, it will be obvious that the film is a watertight and preferably non-breathable film type.

In embodiments, the providing step and the ensuring step are performed automatically. Is in principle possible to perform the steps of providing the steps and of ensuring their correct position(s) manually, such as by manually perforating the film of bales that are in their final storage position, or by rotating or shifting bales with perforations such that the perforations are in a correct position. However, these steps are preferably performed automatically, such as by means of an automated device or separate, dedicated devices. This ensures less work for the farmer, and also allows a better, more constant quality of the perforations and their positions, without the farmer having to act on and check every single bale.

In the present invention, the bale can be a square bale, the perforations preferably being provided in a top surface of the bale only. This can relatively easily be accomplished by perforating the top face after or even during baling the crop material. However, in particularly favourable embodiments, the bale is a round bale with a longitudinal axis and with a cylindrical surface and two flat side surfaces, wherein the perforations are in majority or only provided on the cylindrical surface, and the step of ensuring comprises ensuring that the perforations are provided in the top half of the bale, in particular in the topmost 60°, more in particular in the topmost 45°, in each case on both sides of the top of the bale. Such round bales are nearly always oriented with their axis horizontally, since only then water runs off the side surface, and the wrapping, which is substantially only provided over the cylindrical side surface, in one or more layers, stops ingress of (rain) water. The indicated angles present favourable, and more favourable parts of the bale surface, without providing a too narrow surface part that would present difficulties with precision when providing the perforations, and without too much risk of failing when the bale might roll over a bit after performing the invention, and then the angle being out of scope.

In embodiments, the perforations are provided in at least one row. This allows a good control over the making of the perforations, e.g. because it allows to make the plurality of perforations with a single toll such as a tooth, that is translated over the bale between puncturing the film. Furthermore, it is thus easy to ensure that at least many, or even all, of the perforations are provided in a desired position. Herein, a “row” is a group of perforations that has a length/width ratio over the surface that is at least 10. Nevertheless, it is also possible to provide a plurality of perforations in a different configuration, such as an irregular group, as long as their positions are according to the invention. In particular when the perforations have been provided in a row, but also in other configurations, it is possible that the perforations are provided in a smaller angle with respect to the top of the bale, in particular in the topmost 30°, even more in particular in the topmost 15°. While vapour, that rises to the top, may still escape, the risk of unwanted ingress of rain is now limited even further.

In embodiments, the perforations are provided in a plurality of rows, preferably two or three rows, and more preferably substantially parallel rows. Having a plurality of rows further ensures that there will be perforations at the top of the bale, even in case the bale should be shifted or rotated somewhat. It ensures that the step of ensuring may be less strict. Having two or three rows also ensures that there are not too many perforations. Moreover, parallel rows further ensure that at least some perforations will be at the top of the bale, because a rectangular surface is covered with perforations. Herein, it is possible to provide the rows parallel to the longitudinal axis of the bale. Nevertheless, providing the rows obliquely, i.e at an angle to the axis, offers the advantage that it can be even better guaranteed that some perforations will be on top, even though not all will be. The latter advantage holds in particular for a single row.

In embodiments, a distance between rows is about 0.1 m. rounded off. This distance, both inter-row and between perforations in a row, was found to be a good compromise between having sufficient perforations to allow escape of water vapour, and not having too many holes that would allow too much ingress of (rain) water or would endanger the integrity of the film.

In embodiments, said plurality of perforations is provided over at least half of a length of the bale, as seen along the longitudinal axis. This ensures sufficient possibilities for the water vapour to escape from the bale, in particular for vapour near the center of the bale. Note that near the (uncovered) sides of the bale, vapour may also escape through those vertical flat side surfaces. It is thus not necessary to provide perforations over all of the length of the bale, but it is not excluded. Furthermore, providing perforations over a shorter distance than half of the bale length is not excluded, such as for very short bales.

In some cases, when a bale is deposited, the step of providing the perforations is subsequently performed by hand or by means of an automated tool.

In embodiments, at least a majority, and preferably all, of the perforations comprise each at least three, and preferably four radial slits. It was found that this shape of perforations is advantageous, in that it allows moisture out, but prevents most of the rain water to seep into the bale. This is thought to be due to the flap-like shape of the sides of the perforations, that close off the hole to the outside, while giving away to (vapour) pressure from within. Herein, the slits are preferably formed as at least two crossed slits, under any non-zero angle, preferably a right angle. This may be performed by two slits by a knife or by two knives, or by a correspondingly shaped dedicated tool. This is contrasted to a more or less circular perforation that is made by a needle or the like, that gives rise to a circular opening that no longer closes off against rain.

The object of the invention is also achieved with a system according to claim 9, in particular a system for automatically providing a round bale of crop material that is only partially wrapped in a film, the film of the wrapped bale being provided with a plurality of perforations, the system comprising a round bale wrapper that wraps a bale of crop material partially in a film, a perforator that provides the film with said plurality of perforations, wherein the system is arranged such that said plurality of perforations, after having been provided in the film, are present/positioned in an upper half of the bale, in particular in the topmost 60°, i.e. maximum 30° to the left or to the right from the top, more in particular in the topmost 45°. Herein, the system may comprise one machine that performs all tasks, or be separate machines.

The advantages of the invention have in principle been described above for the method, and thus need not be repeated here. Favourable embodiments are described below, without being limiting.

In embodiments, the system comprises an orienting device arranged to ensure that said plurality of perforations, after having been provided in the film, are present/positioned in the upper half of the bale, in particular in the topmost 60°, more in particular in the topmost 45°. Herein, “ensure” means that the orienting device is arranged to actively orient the perforations correctly during providing same, or to check their orientation afterwards and take corrective action.

In embodiments, the perforator comprises projections that provide, either singly or in combination with at least one other of the projections, a perforation each in the form of at least three, and preferably four, radial slits. As mentioned above, it has been found that such radial slits, with the ensuing flaps, better regulate the water and moisture, by preventing ingress of rain water, while allowing vapour out. Again, there are e.g. at least two crossed slits, under any non-zero angle, preferably a right angle, without excluding other set-ups. Circular holes, by piercing with a needle or the like, are less advantageous, though still possible.

In embodiments, the perforator and the orienting device are combined into one machine. This offers the advantage of easily coordinating the perforating and the orienting. For example, the orienting device, or more precisely its controller, will have knowledge of the orientation of the bale. If then the perforator makes the perforations, it is easy to provide those already in the correct position. Or otherwise, if the perforator makes the perforation, the orienting device will know in what orientation the bale is, and can then correct the orientation if necessary. In particular, the one machine may comprise a bale handler arranged to orient a round bale, and a perforator.

In embodiments, the round bale wrapper is combined with a round baler that forms a round bale, wherein the round bale wrapper is provided inside the round baler and is arranged to wrap the bale while inside the round baler, or wherein round bale wrapper is arranged behind the round baler and the round baler is arranged to transfer the formed bale to the round bale wrapper for wrapping the bale. These arrangements make it possible to handle the bale and wrap and perforate and orient it, all in one machine. This makes the control easier, and also prevents unnecessary lifting and handling of the bale, since it can be treated completely before even touching the ground, although that is of course not excluded. As throughout this application, wrapping the bale means wrapping it in film for part of its outer surface, in particular around its circumference.

In embodiments, the round baler comprises a bale unloading ramp that unloads the bale formed in the round baler, and a bale catcher that holds the unloaded bale in a first position, in particular resting on the ground, in particular the round baler also comprising the perforator. The bale catcher allows to have good knowledge of the position of the bale, because the size of the bale, the length of the bale's track along the unloading ramp and the position in which the bale catcher catches the bale determines the bale's final orientation. Herein, the first position is preferably in contact with the unloading ramp. Thus a good control over that position and orientation can be achieved, which allows the perforating to be performed in a well-controlled fashion either before or after unloading the bale, as will be explained further below.

The perforator may be provided on a separate machine, simply providing the perforations on the bale after its unloading, and thus in its final position. In another embodiment, the bale wrapper and/or the round baler also comprises the perforator. This allows full control over the perforating and the orientation of the perforations.

In embodiments, the perforator is arranged to provide the perforations in the film when the bale is in the first position. In particular, the perforator may be provided on a tailgate of the round baler, the tailgate being arranged to press the perforator onto the film for providing the perforations. Thereto, the tailgate may be moved downwards, onto the top of the bale, either with a separate actuator, or by pressing the tailgate with the perforator onto the film. The perforator may also be provided as a separately actuatable and movable part, either provided on the tailgate or separate thereof but onto the baler, such as a robotized arm that is actuatable by means of an electric, pneumatic or hydraulic cylinder or robot arm.

In embodiments, the perforator comprises a set of teeth arranged on the unloading ramp. When being unloaded, the bale will roll over the teeth, thus providing the perforations. With a known (and possibly fixed) bale size, the final position of the perforations may be controlled by correspondingly positioning the teeth on the ramp. If bales of different sizes may be made by the baler, it is possible to provide more than one set of teeth, or provide a set of teeth that is displaceable over the ramp. In particular, the teeth may be retractable into the ramp, or otherwise be removable from the path of the bale, such as to prevent hindering the baling process.

The perforator may comprise teeth, in particular each tooth being starshaped to provide the radial preferred slits. Other configurations are possible, such as the teeth comprising separate flat knives, oriented such that the bale, and in particular a slit made in its film, will be subjected to more than one knife in a row, when unloading or otherwise. This way, the preferred multiple radial slits may be formed in a two- or more step way. Still, other teeth are not excluded.

In embodiments, the orienting device comprises a round bale handler that is arranged to rotate the round bale around a longitudinal axis of the bale and over such an angle that said plurality of perforations, that have been provided in the film, are present/positioned in said upper half of the bale, in particular in the topmost 60°, more in particular in the topmost 45°. For example, the round bale handler comprises two arms that are positioned left and right of the bale, that grips the bale from below and lift it, while the two arms each have one or more rotatable rolls for rotating the bale into a desired position, that may be controlled by an operator or by means of an automated device. In another embodiment, the round bale handler simply pushes the round bale, such that it rotates over a desired angle.

In embodiments, the orienting device comprises a bale spear, preferably a single tined bale spear that is arranged to penetrate the round bale excentrically and to thereby rotate the round bale around a longitudinal axis of the bale and over such an angle that said plurality of perforations, that have been provided in the film, are present/positioned in said upper half of the bale, in particular in the topmost 60°, more in particular in the topmost 45°. Thus a separate vehicle or machine is provided in the system. The picking up and rotating can be done by an operator, or automatically if the bale spear is automated.

In embodiments, the orienting device comprises an optical detection system that detects at least one of said perforations and that is operatively connected to the orienting device, the orienting device orienting the round bale on the basis of the at least one detected perforation. The detection of the perforations allows automating the device that handles the bale and provides a correct orientation of the perforations. For example, the round bale handler rotates the bale accordingly, or the bale spear penetrates the bale with its tine substantially between the bale's center and the detected perforation(s) and then lifts the bale, that will subsequently correct its orientation gravity-assisted.

The optical detection system may comprise a video camera and image processing software, arranged to detect openings in the film, such as by contrast of the often whitish film to darker holes therein. It is furthermore possible to detect the sharp edges of the perforations, and more in particular the radial slits of the preferred perforations.

### BRIEF DESCRIPTION OF THE DRAWINGS

The invention will now be elucidated in the form of a number of non-limiting exemplary embodiments, shown in the drawing, in which:

FIG. 1a shows a prior art round bale with film with holes,

FIG. 1b shows a round bale provided according to the present invention,

FIG. 1c shows a square bale provided according to the present invention,

FIG. 2 shows a bale according to the invention, in diagrammatic top view,

FIG. 3 shows a diagrammatic view of a bale spear of a system according to the invention, and

FIG. 4 shows a diagrammatic view of a system according to the invention.

### DETAILED DESCRIPTION

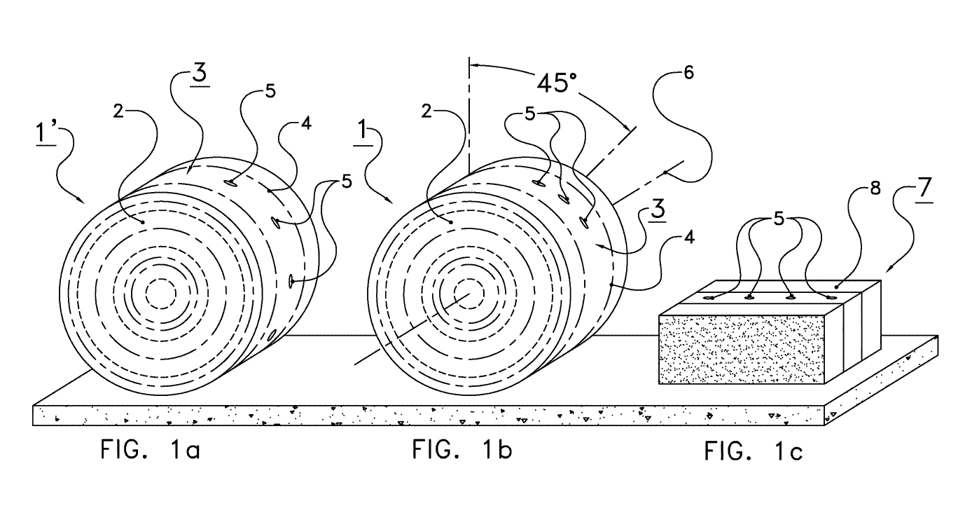

FIG. 1a shows a prior art round bale 1′ with a perforated film, in a diagrammatic perspective view. The baled crop is e.g. dry hay or the like. Herein, the bale 1 has side surfaces 2 and a cylindrical surface 3 that is wrapped in, or covered with, a film 4 that is provided with perforations 5. In this prior art bale, the perforations 5 are provided either regularly or irregularly, but always all around the bale 1′. This entails moisture at ground level to ingress into the bale, which is undesirable. Furthermore, the holes are here circular, and this may also allow ingress of rain water from above, although it is acceptable in some circumstances.

FIGS. 1b and 1c show a round bale 1, and a square bale 7, provided according to the present invention. Similar to bale 1′, the round bale 1 is provided with a film around its cylindrical surface, while the flat side surfaces are substantially wrap free. For this bale, the perforations are provided in the topmost 45°, measured in a vertical plane, i.e. perpendicular to the longitudinal axis 6 of the bale 1. Similarly, the perforations 5 are provided in the top surface of the square bale 7. Having the perforations in the top part of the bale 1, in the top surface 7, respectively, allows the film to remain watertight with respect to moisture at ground level, while allowing vapour to escape. This ensures a better quality in the long term, in particular more freedom from moulds and the like. The angle with respect to the top of the bale, under which the perforations may be provided may also be smaller or larger, up to 90°. All such bales allow the escape of moisture that collected at the higher parts of the bale, due to condensation of evaporated water during lower temperatures at night etc.

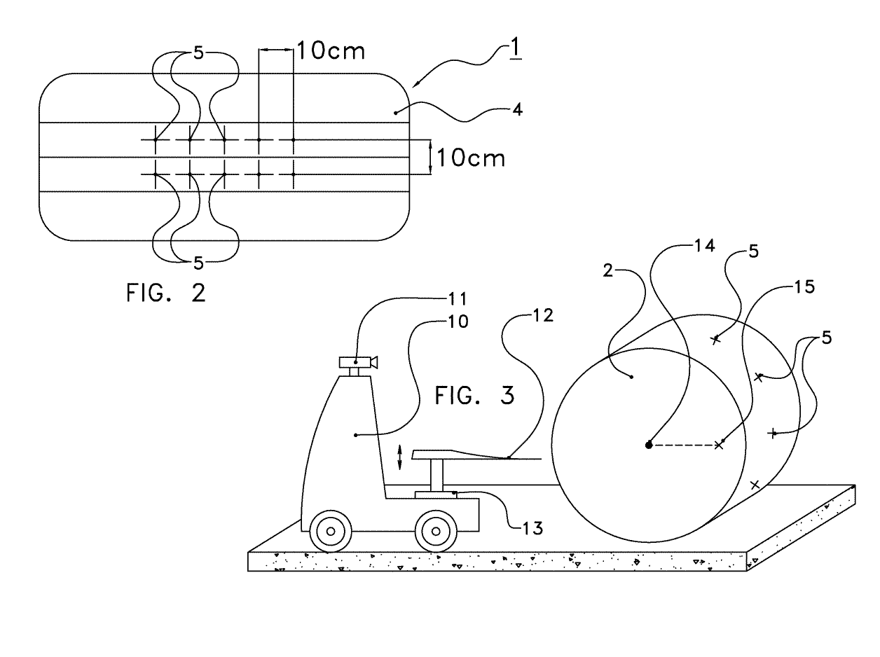

FIG. 2 shows a bale 1 according to the invention, in a diagrammatic top view. Here it is visible that there are two rows of perforations 5. The rows are substantially parallel, and are spaced apart by about 10 cm. Similarly, within a row, the perforations are spaced by about 10 cm from their neighbours. Other distances are possible, such as between about 5 and 15 cm.

The perforations 5 are shown as four radial slits each, which can in this case be equalled to two crossed slits. An important advantage thereof is that the resulting ‘flaps’ close off the perforations during rain or the like, while vapour (moist air etcetera) may still escape easily. This gives better moisture control of the bale. Other slit configurations for the perforations are possible, such as three or four, or even more radial slits.

FIG. 3 shows a diagrammatic view of a bale spear 10 of a system according to the invention. The bale spear 10 comprises a camera 11, a spear or spike 12 and an actuator 13. The bale spear is arranged to ensure that the perforations 5 of the film of a bale 1 are positioned correctly, i.e. at the top of the bale. Thereto, the camera 11, combined with a non-shown image processing device, images the bale 1 and recognizes its perforations 5. It can then rotate the bale 1 such that the perforations are positioned on top, by positioning its spear 12, with the help of the camera 11 and a lifting actuator 13, between the center 14 of the bale and the middle of the detected perforations 5, that is, somewhere on the dashed line in the Figure, such as on the indicated aim 15. When the bale 1 is now lifted, again by means of the actuator 13, gravity will automatically ensure that the perforations 5 are positioned correctly on top. The bale spear 10 may then retract the spear 12 from the bale, and move to another bale.

Alternatively, it is possible for the bale spear, or any other vehicle, autonomous or not, to position the perforations correctly by pushing the bale 1 such that it rolls and rotates over a sufficient angle. This may be monitored by the camera 11.

In this system, the bale spear 10 is only a part, as it handles a wrapped bale 1. This bale may be received from any source, such as a suitable bale wrapper that in turn receives a bale to be wrapped from a baler or picks up a bale from a field, or receives a bale directly from a (round) baler that provides a wrapped bale. The whole of these machines, in any form mentioned, is then an exemplary system according to the invention.

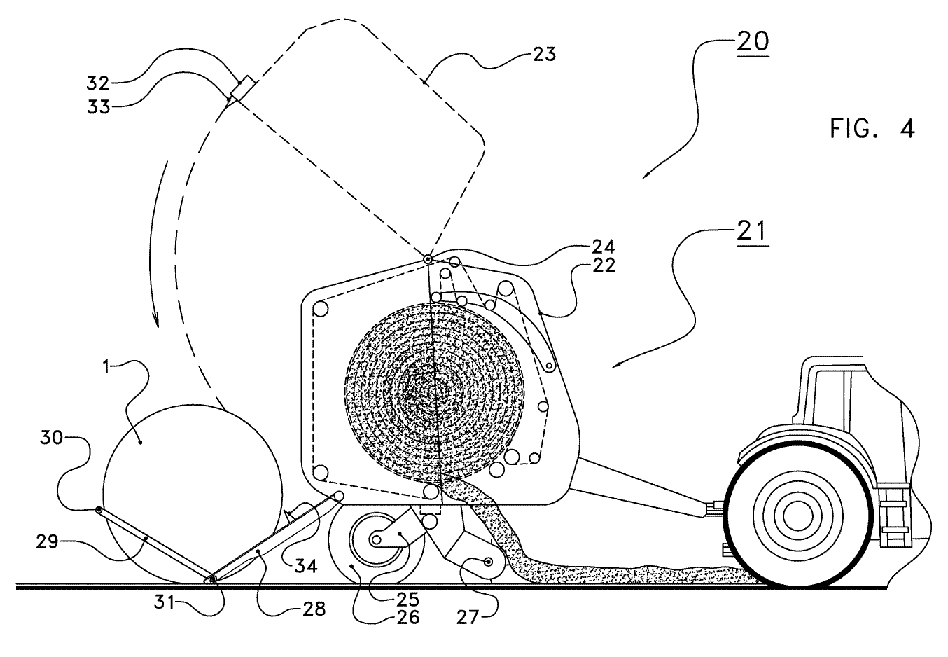

FIG. 4 shows a diagrammatic view of a system according to the invention. The system 20 comprises a round baler 21, that comprises a first baler half 22 and a tailgate 23, that is pivotable about a pivot 24, all being provided on a frame 25 with wheels 26. A pick-up device is indicated with 27, and an unloading ramp with 28. A bale catcher 29 with stops 30 that are swivellable about a joint 31 is also provided. A perforator 32 with retractable teeth 33 is provided on the tailgate, as well as in the form of teeth 34 on the ramp 28.

The system 20 according to the invention is arranged to pick up a crop (not shown) with the pick-up device 27, that is led into the round baler 21, that bales the crop into a bale inside the bale chamber, formed by the first baler half 22 and the tailgate 23. Herein, parts such as baler belts and an internal wrapping device are not shown. Details thereof are not relevant for the invention per se, and may be supplied by any skilled person. It is alternatively also possible to provide a separate bale wrapper, that either receives a bale to be wrapped from a round baler, or is a separate vehicle that is arranged to pick up a bale itself or be provided with a bale by a bale handler, and subsequently wraps a received bale. In all these cases, the bale wrapper is arranged to wrap the bale automatically, and substantially along a cylindrical surface of a round bale or four faces of a square bale. Again, details of such bale wrappers are readily available in the prior art and need not be elucidated here.

When baling and wrapping the bale is finished, it is ejected from the baler 21 by opening the tailgate 23, and unloading the bale 1 via the unloading ramp 28. There may be provided a bale catcher, comprising one or two arms 29 with a stop 30 and that can swivel about a joint 31. The bale catcher can catch the unloading bale, in a fixed position in which it e.g. touches the ground. There is furthermore provided a perforator 32 on the tailgate 23. The tailgate 23 may be moved downward, along the dashed line in the direction of the arrow, which may move the perforator 32 onto the upper side of the bale 1, such that it drives the teeth 33 of the perforator, that have now been extended, through the film of the bale 1. This makes perforations in the bale's film. After that, the bale catcher arm(s) 29 is swivelled out of the way about the joint 31, which fully releases the bale 1. Note, however, that the bale will not move further since it already lay on the ground. Thus there is full control over the position of the perforations. Finally, the teeth 33 may be retracted, and the tailgate 23 may close the round baler 21.

Alternatively, there are provided teeth on the ramp 28, retractable or not. When a bale is unloaded via the ramp, the teeth will be pressed through the film of a bale due to the bale's weight. By positioning the teeth 33 such that the bale will rotate the perforations to an upper position, sufficient control over the perforations' position is also achieved.

What is claimed is:

1. Method for providing a bale of crop material that is only partially wrapped in a film which is provided with a plurality of perforations, the method comprising the steps of
wrapping a bale of crop material in a film with an automatic bale wrapping apparatus,
subsequently providing the film with said plurality of perforations, and
ensuring that the perforations are present/positioned in an upper half of the bale.

2. Method according to claim 1, wherein the providing step and the ensuring step are performed automatically.

3. Method according to claim 1, wherein the bale is a round bale with a longitudinal axis and with a cylindrical surface and two flat side surfaces, wherein the perforations are in majority or only provided on the cylindrical surface, and wherein the step of ensuring comprises ensuring that the perforations are provided in the top half of the bale, in particular in the topmost 60°, more in particular in the topmost 45°.

4. Method according to claim 1, wherein the perforations are provided in at least one row.

5. Method according to claim 1, wherein the perforations are provided in a plurality of, preferably two or three, more preferably substantially parallel, rows.

6. Method according to claim 5, wherein a distance between rows is about 0.1 m.

7. Method according to claim 2, wherein said plurality of perforations is provided over at least half of a length of the bale, as seen along the longitudinal axis.

8. Method according to claim 1, wherein at least a majority, and preferably all, of the perforations comprise each at least three, and preferably four radial slits.

9. System for automatically providing a round bale of crop material that is only partially wrapped in a film, the film of the wrapped bale being provided with a plurality of perforations, the system comprising:
a round bale wrapper that wraps a bale of crop material partially in a film,
a perforator that provides the film with said plurality of perforations,
wherein the system is arranged such that said plurality of perforations, after having
been provided in the film, are present/positioned in an upper half of the bale, in particular in the topmost 60°, more in particular in the topmost 45°.

10. System according to claim 9, comprising an orienting device arranged to ensure that said plurality of perforations, after having been provided in the film, are present/positioned in the upper half of the bale, in particular in the topmost 60°, more in particular in the topmost 45°.

11. System according to claim 9, wherein the perforator comprises projections that provide, either singly or in combination with at least one other of the projections, a perforation each in the form of at least three, and preferably four, radial slits.

12. System according to claim 9, wherein the perforator and the orienting device are combined into one machine.

13. System according to claim 9, wherein the round bale wrapper is combined with a round baler that forms a round bale, wherein the round bale wrapper is provided inside the round baler and is arranged to wrap the bale while inside the round baler, or wherein round bale wrapper is arranged behind the round baler and the round baler is arranged to transfer the formed bale to the round bale wrapper for wrapping the bale.

14. System according to claim 13, wherein the round baler comprises a bale unloading ramp that unloads the bale formed in the round baler, and a bale catcher that holds the unloaded bale in a first position, in particular resting on the ground, in particular the round baler also comprising the perforator.

15. System according to claim 14, wherein the perforator is arranged to provide the perforations in the film when the bale is in the first position, in particular the perforator being provided on a tailgate of the round baler, the tailgate being arranged to press the perforator onto the film for providing the perforations.

16. System according to claim 14, wherein the perforator comprises a set of teeth arranged on the unloading ramp.

17. System according to claim 9, wherein the orienting device comprises a round bale handler that is arranged to rotate the round bale around a longitudinal axis of the bale and over such an angle that said plurality of perforations, that have been provided in the film, are present/positioned in said upper half of the bale, in particular in the topmost 60°, more in particular in the topmost 45°.

18. System according to claim 9, wherein the orienting device comprises a bale spear, preferably a single tined bale spear that is arranged to penetrate the round bale excentrically and to thereby rotate the round bale around a longitudinal axis of the bale and over such an angle that said plurality of perforations, that have been provided in the film, are present/positioned in said upper half of the bale, in particular in the topmost 60°, more in particular in the topmost 45°.

19. System according to claim 9, wherein the orienting device comprises an optical detection system that detects at least one of said perforations and that is operatively connected to the orienting device, the orienting device orienting the round bale on the basis of the at least one detected perforation.
